(19) United States
(12) Patent Application Publication
(10) Pub. No.: US 2014/0304123 A1
(43) Pub. Date: Oct. 9, 2014

(54) ELECTRONICALLY TRACKING INVENTORY IN A RETAIL STORE

(71) Applicant: INTERNATIONAL BUSINESS MACHINES CORPORATION, Armonk, NY (US)

(72) Inventor: Robyn R. Schwartz, Chicago, IL (US)

(73) Assignee: International Business Machines Corporation, Armonk, NY (US)

(21) Appl. No.: 13/859,155

(22) Filed: Apr. 9, 2013

(51) Int. Cl. G06Q 10/08

(52) U.S. Cl. CPC G06Q 10/087
USPC 705/28; 235/385

(57) ABSTRACT

A computer receives a calculation of an approximate location of a product, an expected location of the product and an unique identifier of the product, based on a product inquiry. The computer stores the calculation of the approximate location of the product in a database, and associates the calculation of the approximate location of the product to the unique identifier, within the database. The computer compares the calculation of the approximate location of the product with the expected location of the product, and extracts all calculations of the approximate location of the product from the database. The computer generates a data set that includes each of the calculations of the approximate location of the product extracted, computes a mode and a median of the data set, and updates an electronic planogram to show an image of current placement of each product available for sale within inventory of the retail store.

### BACKGROUND

1. Field of the Invention

The present invention relates generally to inventory tracking, and more specifically to electronically tracking inventory in a retail store.

2. Description of the Related Art

Retail store shelves must be adequately and timely stocked to ensure sales opportunities are not missed. Adequately and timely stocking the store shelves can be challenging for retailers, but if achieved can maximize revenue for the retailers and satisfy their customer's expectations. Specifically, there can be many challenges to stocking store shelves one of which is tracking products with high consumer demand, because products with high consumer demand can sell out quickly. Moreover, even adequately and timely stocking store shelves having products with low consumer demand can be challenging, because such products may not be diligently tracked by retailers to identify when the products are out of stock within the inventory.

It is known for manufacturers and suppliers of products to utilize various promotional events to increase sales of products within a retail store's inventory. However, retailers can face additional challenges in ensuring visibility of the products when stocking shelves with the products for the promotional events. In particular, the visibility of the products during the promotional events is important for increasing the sales. For example, placement of products at end caps of aisles, in main alleys of a store, or in other high consumer traffic areas can significantly increase sales of the products. Thus, in order to increase sales retailers may establish policies and procedures for manually tracking products to ensure they are correctly placed in order to maximize visibility of the products, and may even use promotional displays to encourage customers to purchase the products. However, promotional displays and products are often unintentionally moved around by customers and may even be inadvertently misplaced by retail store employees. Therefore, such manually tracking can be very inaccurate and time consuming and must be performed on a continual or perpetual basis to ensure a real-time view. There are technology solutions that can be implemented at a cost (such as but not limited to item level tracking via RFID).

In addition, it is common for manufacturers to ship the promotional displays to retailers, to be placed in main alleys of the store and other areas of the store having high consumer visibility and/or high consumer traffic. The retailers can have obligations to receive and place the promotional displays and products associated with the displays, on sales floors at specific locations and designated times. As a result, an additional challenge associated with such promotional displays and associated products is tracking compliance with the obligations. In particular, retailers that sell and manage hundreds and thousands of different products within an inventory may have difficulty tracking promotional displays and associated products to ensure they are moved to the sales floor at the designated times.

Furthermore, retail store management often utilize aggregate point-of-sale data in order to maintain adequate inventory levels to meet customer demands. However, there can be significant latency in receiving the point-of-sale data into an inventory management system and/or a work force or labor management system, which can result in having inadequate inventory levels. Thus, in order to maintain adequate inventory levels, many retailers spend a lot of time, effort, and money tracking the movement of the products within their inventory. It is known for retail stores to utilize in-store technologies such radio-frequency identification (RFID) readers and video devices for tracking of the products. However, many of the in-store technologies for tracking products can be very costly to install, maintain, and integrate with other retail store computer software to produce the downstream effect of linking collected data to relevant computer software systems.

### SUMMARY

Aspects of an embodiment of the present invention disclose a method, computer system, and program product for electronically tracking inventory in a retail store. A computer receives a calculation of an approximate location of a product, an expected location of the product and an unique identifier of the product. The computer stores the calculation of the approximate location of the product in a database. The computer associates the calculation of the approximate location of the product to the unique identifier of the product, within the database. The computer compares the calculation of the approximate location of the product with the expected location of the product. The computer extracts all calculations of the approximate location of the product from the database. The computer generates a data set that includes each of the calculations of the approximate location of the product extracted. The computer computes a mode of the data set. The computer updates an electronic planogram to show an image of current placement of each product available for sale within inventory of the retail store.

### BRIEF DESCRIPTION OF THE SEVERAL VIEWS OF THE DRAWINGS

The subject matter which is regarded as an embodiment of the present invention is particularly pointed out and distinctly claimed in the claims at the conclusion of the specification. One manner in which recited features of an embodiment of the present invention can be understood is by reference to the following detailed description of embodiments, taken in conjunction with the accompanying drawings in which:

FIG. 1 is a block diagram of a distributed computer system, including a client computing device having a product identification program that interacts with a shopper inventory tracker program on a server computer, wherein the shopper inventory tracker program receives data from the product identification program and utilizes the data to update inventory management metrics and an electronic planogram within an inventory software system on the server computer according to an embodiment of the present invention.

FIGS. 2A and 2B are flowcharts illustrating operations of the shopper inventory tracker program utilizing the data from the product identification program to update the inventory management metrics and the electronic planogram within the inventory software system of FIG. 1 according to an embodiment of the present invention.

FIG. 3 is a block diagram depicting internal and external components of the client computing device and the server computer of FIG. 1 according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like, conventional procedural programming languages such as the “C” programming language, a hardware description language such as VERILOG, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Embodiments of the present invention provide a shopper inventory tracker program having program code for electronically tracking inventory in a retail store. Specifically, the shopper inventory tracker program is installed on a server computer and receives data from a product identification program on a client computing device (e.g., a smartphone or other mobile computing device). The shopper inventory tracker program utilizes the data received to update inventory management metrics and information, and to update an electronic planogram within an inventory software system on the server computer. Retail store management can utilize the shopper inventory tracker program to maintain adequate inventory levels to meet customer demands, and track the location of products and even assets within a retail store.

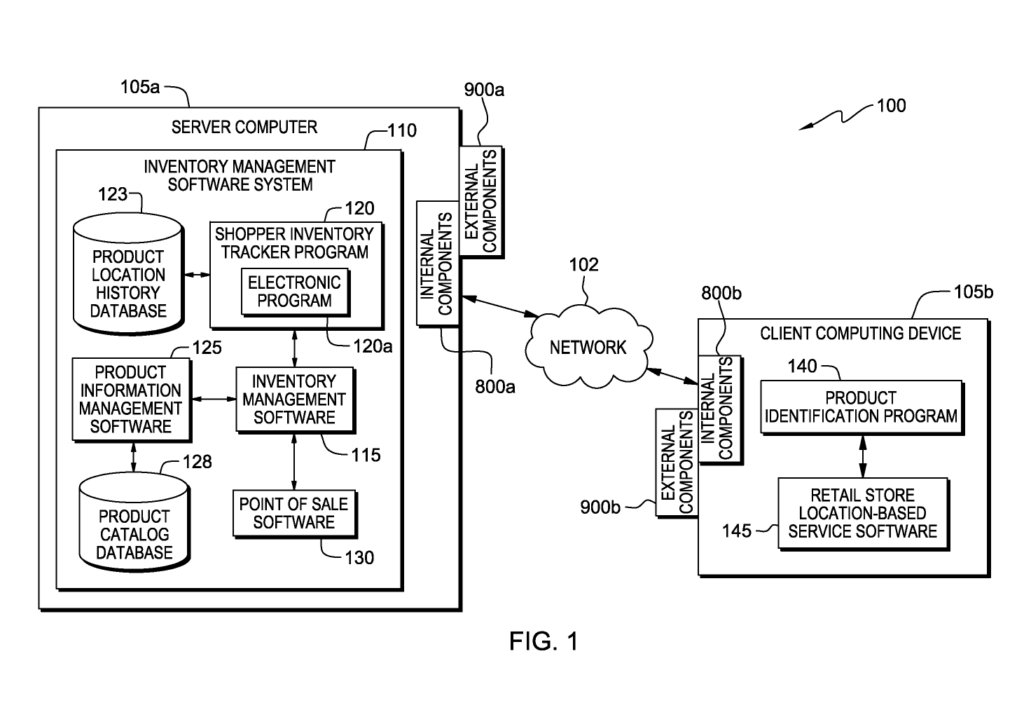

FIG. 1 illustrates computer system 100 that includes network 102, server computer computer 105a, and client computing device 105b. Server computer 105a is installed with computer program software that includes the following: inventory management software 115, shopper inventory tracker program 120 with electronic planogram 120a that defines the expected location of each product within a retail store, product information management software 125, and point of sale software 130. Client computing device 105b is also installed with computer program software that includes product identification program 140 and retail store location-based service software 145. Computer system 100 can leverage generalized shopper (i.e., customer) queries from product identification program 140 to collect information and insight into product location and inventory levels. In particular, computer system 100 may leverage retailer specific pre-determined consumer application, but does not have to be dependent on a shopper's compliance with utilizing the pre-determined consumer application. The shopper can perform queries (i.e., requests), client computing device 105b, for product information by inputting (i.e., scanning or manually entering) into product identification program 140 a product name and/or description via various means including, but not limited to: a barcode (e.g., a quick response code), Bluetooth interaction with the product, radio-frequency identification (RFID), a universal product code (UPC), and a stock-keeping unit (SKU) code.

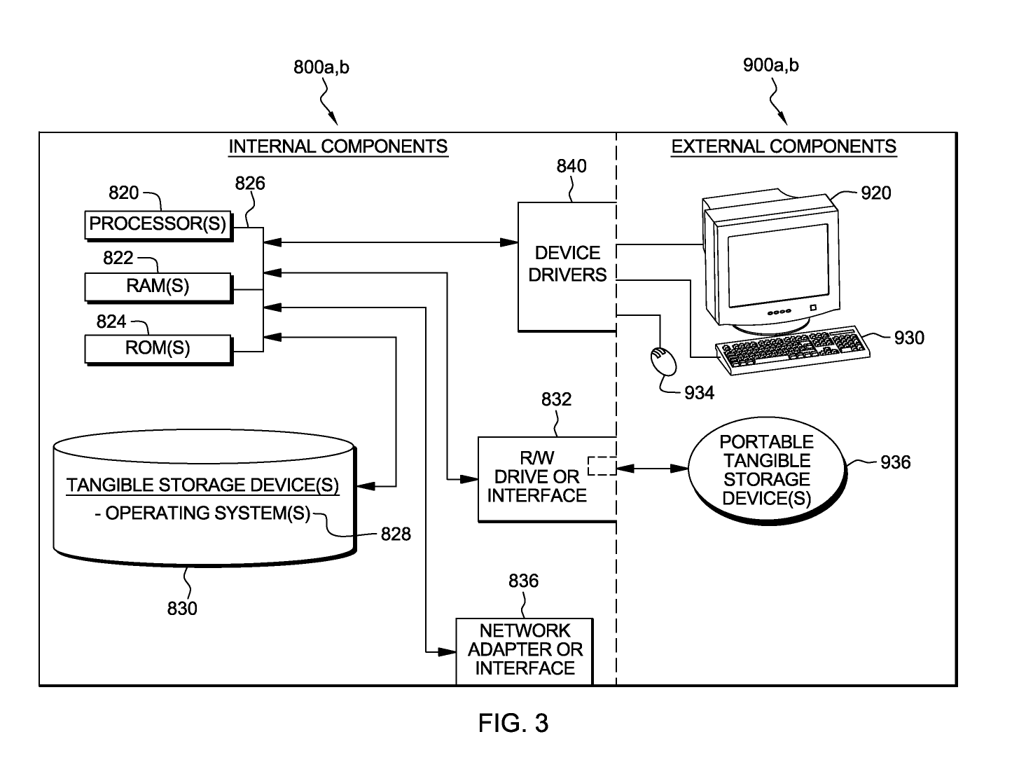

Client computing device 105b can be a cellular phone (e.g., smartphone), tablet, or any other portable electronic computing device that is capable of running computer program software such as product identification program 140 and retail store location-based service software 145, and capable of scanning a barcode (i.e., making a product inquiry) and/or receiving manually entered data (e.g., UPC, quick response code, SKU code, unique descriptor, or a combination thereof) with information that can be utilized to identify a product and an expected location of the product. For example, the barcode can be a two-dimensional barcode (e.g., a quick response code). In addition, server computer 105a and client computing device 105b each include respective internal components 800a and 800b, and respective external components 900a and 900b, as described below in more detail with respect to FIG. 3.

Inventory management software 115 is a computer software application that is configured to compute the quantity of products available for sale within the retail store's inventory. Shopper inventory tracker program 120 receives data from product identification program 140, wherein the data can include a unique product identifier (ID) and an expected location of a product having a barcode that is scanned by client computing device 105b. In addition, shopper inventory tracker program 120 can receive information from retail store location-based service software 145 or from some other means of identifying the location of the consumer owned device, for a product having a barcode (e.g., quick response code, RFID tag, SKU code, or UPC). The information received includes a calculation of the approximate location of the product at the time the product was last queried (e.g., the time a barcode of the product was last scanned) by client computing device 105b (e.g., a shopper owned or store owned associate device). Shopper inventory tracker program 120 can store each calculation of the approximate location of a product received, in product location history database 123. Moreover, each calculation stored in product location history database 123 can be associated to a unique identifier of the product based on which the calculation was made.

Moreover, shopper inventory tracker program 120 can send a request to inventory management software 115 to return specific product information, from product catalog database 128, wherein the product information can be extracted by product information management software 125 and sent to shopper inventory tracker program 120 via inventory management software 115. The product information extracted from product catalog database 128, for a product, can include the following: fit of the product, season of the product, style of the product, stock-keeping unit (SKU) of the product, aspect ratio of the product, weight of the product, expiration of the product, and an electronic image representing the product. Shopper inventory tracker program 120 manages electronic planogram 120a that provides a graphical representation of the location and quantity of each product on the sales floor of the retail store. Shopper inventory tracker program 120 can utilize the product information, mentioned above, that is extracted to generate electronic planogram 120a defining a location and a quantity of each within the retail store at a specific point in time. Furthermore, inventory management software 115 is configured to interact with point of sale software 130 that records each sale transaction of a product, utilize each sale transaction that is recorded to update the quantity of products available for sale within the retail store's inventory, and send a notification of each sale transaction of a product to shopper inventory tracker program 120. Shopper inventory tracker program 120 can utilize each notification of a sale transaction to generate an updated version of electronic planogram 120a having an updated quantity for each product in the sale transaction.

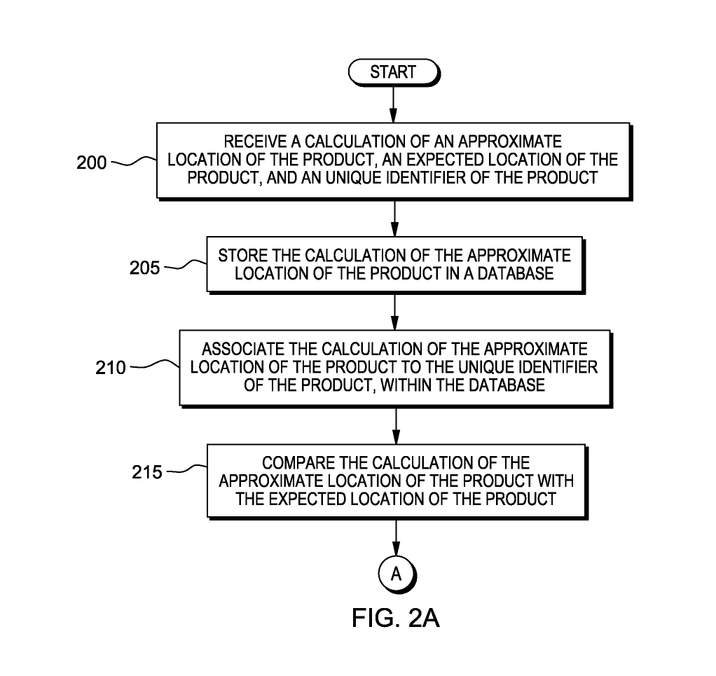

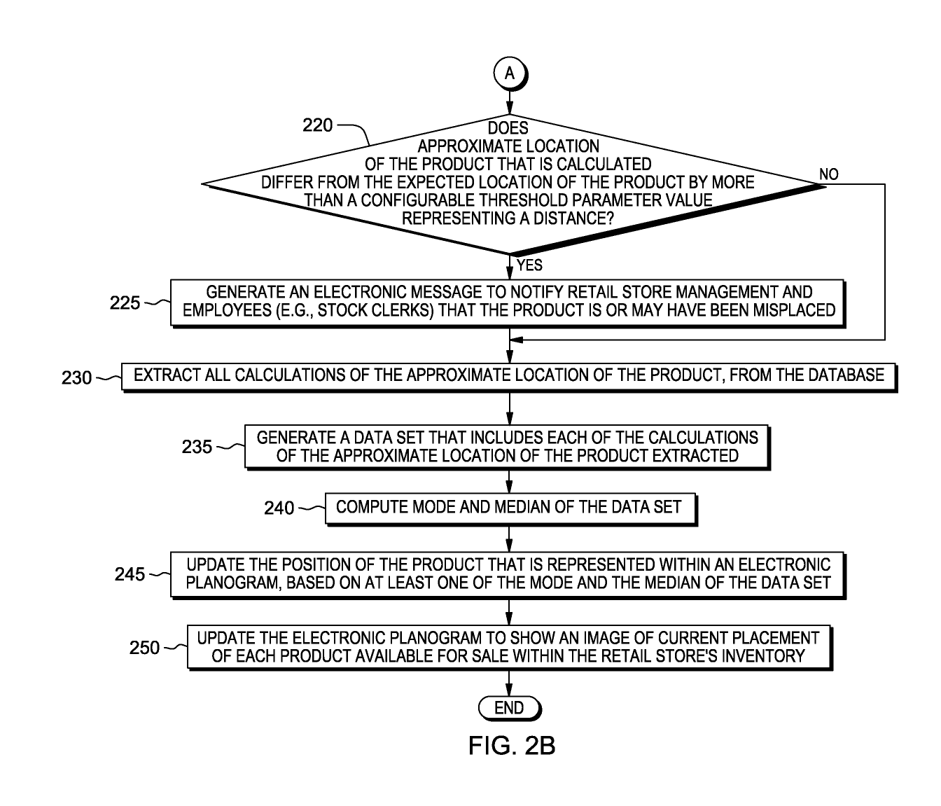

FIGS. 2A and 2B are flowcharts illustrating the steps of the program code of shopper inventory tracker program 120 in more detail. In response to a shopper in a retail store scanning a barcode (e.g., a quick response code) or performing some other type of query (e.g., manual input of SKU, etc.) for product information, via client computing device 105b, on a product within the retail store's inventory, product identification program 140 collects information from the barcode. As mentioned above, the barcode can be a quick response (QR) code, RFID tag, SKU code, or UPC. The information collected from the barcode can be utilized to identify the product and an expected location of the product. The information from the barcode can include the following: a unique identifier of the product, expected location of the product within the retail store, expiree, days in inventory, size, color, fit, season, style, vendor, department, ingredients, fabrics, contents, unit in package, dimensions, price, and promotions. The barcode can be a two-dimensional barcode (e.g., a quick response code) that can contain an expected location of the product within the store and even a uniform resource locator (URL) to access product information stored in product catalog database 128.

In addition, in response to a shopper scanning the barcode on the product, barcode scanner program 140 instructs retail store location-based service software 145 to calculate an approximate location of the product, based on where client computing device 105b was located at the time client computing device 105b was utilized to scan the barcode. Thus, each time the barcode on the product within the retail store's inventory is scanned utilizing product identification program 140, retail-store location-based service software 145 calculates an approximate location of the product, and sends each calculation of the approximate location of the product to product identification program 140. In response to receiving a calculation of the approximate location of the product, product identification program sends the calculation of the approximate location, the expected location, and the unique identifier of the product to shopper inventory tracker program 120.

Next, shopper inventory tracker program 120 receives the calculation of the approximate location of the product, the expected location of the product, and the unique identifier of the product (block 200). Subsequently, shopper inventory tracker program 120 stores the calculation of the approximate location of the product in location history database 123 (block 205), and associates the calculation of the approximate location of the product to the unique identifier of the product, within location history database 123 (block 210). Thus, if more shoppers scan the barcode on the product, then more calculations of the approximate location of the product are stored, by shopper inventory tracker program 120, in location history database 123 and are associated to the unique identifier of the product. Next, shopper inventory tracker program 120 compares the calculation of the approximate location of the product with the expected location of the product (block 215). Subsequently, shopper inventory tracker program 120 determines whether the approximate location of the product that is calculated differs from the expected location of the product by more than a configurable threshold parameter value representing a distance (decision block 220).

If the approximate location of the product does not differ from the expected location of the product by more than the configurable threshold parameter value representing a distance (decision block 220, “NO” branch), then shopper inventory tracker program 120 extracts all calculations of the approximate location of the product, from product location history database 123 (block 230). Otherwise, if the approximate location of the product that is calculated differs from the expected location of the product by more than a configurable threshold parameter value representing a distance (decision block 220, “YES” branch), then shopper inventory tracker program 120 generates an electronic message to notify retail store management and employees (e.g., stock clerks) that the product is or may have been misplaced (block 225). In the disclosed embodiment, the configurable threshold parameter value ranges from about twenty meters to fifty meters. Shopper inventory tracker program 120 sends the electronic message that is generated to inventory management software 115, wherein inventory management software 115 can broadcast the message to employees. Afterwards, shopper inventory tracker program 120 extracts all calculations of the approximate location of the product (block 230).

Next, shopper inventory tracker program 120 generates a data set that includes each of the calculations of the approximate location of the product extracted (block 235), and computes mode and median of the data set (block 240). Thus, the more calculations of the approximate location of the product within the data set the more accurate the computation of the mode can be. Subsequent to computing the mode and the median of the data set, shopper inventory tracker program 120 updates the position of the product that is represented within electronic planogram 120a, based on at least one of the mode and the median of the data set (block 245). In response to updating the position of the product within electronic planogram 120a, shopper inventory tracker program 120 updates electronic planogram 120a to show an image of the current placement of each product available for sale within the retail store's inventory (block 250). Furthermore, the updating of electronic planogram 120a and also include updating related software systems (e.g., labor management software system and/or order management software system) based on data generated from shopper queries for product information, via client computing device 105b, in order to make the data generated actionable (i.e., useful) for various purposes such as data analytics and reporting. Accordingly, an end-user (e.g., retail store employee) of shopper inventory tracker program 120 can utilize electronic planogram 120a to identify products that have been misplaced. Moreover, fixed assets may also be tracked and shown in electronic planogram 120a in the same manner described above. Subsequent to updating electronic planogram 120a the program code ends.

FIG. 3 is a block diagram depicting a set of internal components 800a and 800b and a set of external components 900a and 900b that correspond to respective server computer 105a and client computing device 105b. Internal components 800a and 800b each include one or more processors 820, one or more computer readable RAMs 822 and one or more computer readable ROMs 824 on one or more buses 826, and one or more operating systems 828 and one or more computer readable tangible storage devices 830. The one or more operating systems 828, inventory management software 115, shopper inventory tracker program 120 with electronic planogram 120a, product information management software 125, and point of sale software 130 on server computer 105a; and product identification program 140 and retail store location-based service software 145 or some other location based services technology on client computing device 105b are stored on one or more of the respective computer readable tangible storage devices 830 for execution by one or more of the respective processors 820 via one or more of the respective RAMs 822 (which typically include cache memory). In the embodiment illustrated in FIG. 3, each of the computer readable tangible storage devices 830 is a magnetic disk storage device of an internal hard drive. Alternatively, each of the computer readable tangible storage devices 830 is a semiconductor storage device such as ROM 824, EPROM, flash memory or any other computer readable tangible storage device that can store a computer program and digital information.

Each set of internal components 800a and 800b includes a R/W drive or interface 832 to read from and write to one or more portable computer readable tangible storage devices 936 such as CD-ROM, DVD, memory stick, magnetic tape, magnetic disk, optical disk or semiconductor storage device. Inventory management software 115, shopper inventory tracker program 120 with electronic planogram 120a, product information management software 125, and point of sale software 130 on server computer 105a; and product identification program 140 and retail store location-based service software 145 or some other location based services technology on client computing device 105b can be stored on one or more of the respective portable computer readable tangible storage devices 936, read via the respective R/W drive or interface 832 and loaded into the respective hard drive or computer readable tangible storage device 830.

Furthermore, each set of internal components 800a and 800b also includes a network adapter or interface 836 such as TCP/IP adapter card, wireless wi-fi interface card, or 3G or 4G wireless interface card or other wired or wireless communication link. Inventory management software 115, shopper inventory tracker program 120 with electronic planogram 120a, product information management software 125, and point of sale software 130 on server computer 105a; and product identification program 140 and retail store location-based service software 145 or some other location based services technology on client computing device 105b can be downloaded to respective server computer 105a and client computing device 105b from an external computer or external storage device via a network (for example, the Internet, a LAN, or a WAN) and respective network adapters or interfaces 836. From the network adapter or interface 836, inventory management software 115, shopper inventory tracker program 120 with electronic planogram 120a, product information management software 125, and point of sale software 130 on server computer 105a; and product identification program 140 and retail store location-based service software 145 on client computing device 105b are loaded into at least one respective hard drive or computer readable tangible storage device 830. The network may comprise copper wires, optical fibers, wireless transmission, routers, firewalls, switches, gateway computers and/or servers.

Each set of external components 900a and 900b can include a computer display monitor 920, a keyboard 930, and a computer mouse 934. External components 900a and 900b can also include touch screens, virtual keyboards, touch pads, pointing devices, and other human interface devices. Each set of internal components 800a and 800b also includes device drivers 840 to interface to computer display monitor 920, keyboard 930 and computer mouse 934. The device drivers 840, R/W drive or interface 832 and network adapter or interface 836 comprise hardware and software in which the software is stored in computer readable tangible storage device 830 and/or ROM 824.

It should be appreciated that FIG. 3 provides only an illustration of one implementation and does not imply any limitations with regard to the environments in which different embodiments may be implemented. A variety of modifications to the depicted environments may be implemented. Moreover, a variety of modifications to the depicted environments may be made based on design and implementation requirements.

In accordance with the foregoing, a method, a computer system, and a computer program product have been disclosed for electronically tracking inventory in a retail store. However, numerous modifications substitutions can be made without deviating from the scope of an embodiment of the invention. Therefore, one or more embodiments of the invention have been disclosed by way of example and not limitation.

What is claimed is:

1. A method for electronically tracking inventory in a retail store, the method comprising the steps of:
receiving a calculation of an approximate location of a product, an expected location of the product and an unique identifier of the product;
storing the calculation of the approximate location of the product in a database;
associating the calculation of the approximate location of the product to the unique identifier of the product, within the database;
comparing the calculation of the approximate location of the product with the expected location of the product;
extracting all calculations of the approximate location of the product from the database;
generating a data set that includes each of the calculations of the approximate location of the product extracted;
computing a mode and a median of the data set; and
updating an electronic planogram to show an image of current placement of each product available for sale within inventory of the retail store.

2. The method of claim 1, wherein the calculation of the approximate location of the product is generated from a portable electronic computing device capable of at least one of scanning a barcode and receiving manually entered data, wherein the barcode and the data each have information utilized to identify the product and an expected location of the product, and wherein the barcode and the data each include a universal product code, a quick response code, a stock-keeping unit code, a unique descriptor, or a combination thereof.

3. The method of claim 1, wherein the step of comparing the calculation of the approximate location of the product with the expected location of the product comprises generating an electronic message indicating that the product is misplaced, if the approximate location of the product that is calculated differs from the expected location of the product by a configurable threshold parameter value.

4. The method of claim 3, wherein the configurable threshold parameter value ranges from about twenty meters to fifty meters.

5. The method of claim 1, wherein the step of updating the electronic planogram comprises updating a position of the product that is represented within the electronic planogram, based on at least one of the mode and the median of the data set computed.

6. The method of claim 1, wherein the step of updating the electronic planogram comprises updating a least one of a labor management software system and an order management software system based on data generated from one or more queries for product information, which makes the data generated from the one or more queries useful for various purposes that include data analytics and reporting.

7. A computer program product for electronically tracking inventory in a retail store, the computer program product comprising:
a computer readable tangible storage device and program instructions stored on the computer readable tangible storage device, the program instructions include:
program instructions to receive a calculation of an approximate location of a product, an expected location of the product and an unique identifier of the product;
program instructions to store the calculation of the approximate location of the product in a database;
program instructions to associate the calculation of the approximate location of the product to the unique identifier of the product, within the database;
program instructions to compare the calculation of the approximate location of the product with the expected location of the product;
program instructions to extract all calculations of the approximate location of the product from the database;
program instructions to generate a data set that includes each of the calculations of the approximate location of the product extracted;
program instructions to compute a mode and a median of the data set; and
program instructions to update an electronic planogram to show an image of current placement of each product available for sale within inventory of the retail store.

8. The computer program product of claim 7, wherein the calculation of the approximate location of the product is generated from a portable electronic computing device capable of at least one of scanning a barcode and receiving manually entered data, wherein the barcode and the data each have information utilized to identify the product and an expected location of the product, and wherein the barcode and the data each include a universal product code, a quick response code, a stock-keeping unit code, a unique descriptor, or a combination thereof.

9. The computer program product of claim 7, wherein the program instructions to compare the calculation of the approximate location of the product with the expected location of the product comprises generating an electronic message indicating that the product is misplaced, if the approximate location of the product that is calculated differs from the expected location of the product by a configurable threshold parameter value.

10. The computer program product of claim 9, wherein the configurable threshold parameter value ranges from about twenty meters to fifty meters.

11. The computer program product of claim 7, wherein the program instructions to update the electronic planogram comprises updating a position of the product that is represented within the electronic planogram, based on at least one of the mode and the median of the data set computed.

12. The computer program product of claim 7, wherein the program instructions to update the electronic planogram comprises updating a least one of a labor management software system and an order management software system based on data generated from one or more queries for product information, which makes the data generated from the one or more queries useful for various purposes that include data analytics and reporting.

13. A computer system for electronically tracking inventory in a retail store, the computer system comprising:
one or more processors, one or more computer readable memories, one or more computer readable storage media, and program instructions stored on the one or more storage media for execution by the one or more processors via the one or more memories, the program instructions comprising:
program instructions to receive a calculation of an approximate location of a product, an expected location of the product and an unique identifier of the product;
program instructions to store the calculation of the approximate location of the product in a database;
program instructions to associate the calculation of the approximate location of the product to the unique identifier of the product, within the database;
program instructions to compare the calculation of the approximate location of the product with the expected location of the product;
program instructions to extract all calculations of the approximate location of the product from the database;
program instructions to generate a data set that includes each of the calculations of the approximate location of the product extracted;
program instructions to compute a mode and a median of the data set; and
program instructions to update an electronic planogram to show an image of current placement of each product available for sale within inventory of the retail store.

14. The computer system of claim 13, wherein the calculation of the approximate location of the product is generated from a portable electronic computing device capable of at least one of scanning a barcode and receiving manually entered data, wherein the barcode and the data each have information utilized to identify the product and an expected location of the product, and wherein the barcode and the data each include a universal product code, a quick response code, a stock-keeping unit code, a unique descriptor, or a combination thereof.

15. The computer system of claim 13, wherein the program instructions to compare the calculation of the approximate location of the product with the expected location of the product comprises generating an electronic message indicating that the product is misplaced, if the approximate location of the product that is calculated differs from the expected location of the product by a configurable threshold parameter value.

16. The computer system of claim 15, wherein the configurable threshold parameter value ranges from about twenty meters to fifty meters.

17. The computer system of claim 13, wherein the program instructions to update the electronic planogram comprises updating a position of the product that is represented within the electronic planogram, based on at least one of the mode and the median of the data set computed.

18. The computer system of claim 13, wherein the program instructions to update the electronic planogram comprises updating a least one of a labor management software system and an order management software system based on data generated from one or more queries for product information, which makes the data generated from the one or more queries useful for various purposes that include data analytics and reporting.
